(19) United States
(12) Patent Application Publication
(10) Pub. No.: US 2014/0164637 A1
(43) Pub. Date: Jun. 12, 2014

(54) APPARATUS, SYSTEM, AND METHOD FOR RECEIVING MULTIMEDIA CONTENT OVER A MULTICAST ENABLED NETWORK

(71) Applicant: ZiFi Networks a dba of Vuecom, LLC, South Jordan, UT (US)

(72) Inventors: Robert B. Vukich, South Jordan, UT (US); Eric Hermann, Centerville, UT (US); Terry Pohlsander, Audubon, IA (US); Hal J. Rushton, South Jordan, UT (US)

(21) Appl. No.: 13/843,564

(22) Filed: Mar. 15, 2013

Related U.S. Application Data
(60) Provisional application No. 61/734,791, filed on Dec. 7, 2012.

(51) Int. Cl. H04L 29/06

(52) U.S. Cl. CPC H04L 65/60
USPC 709/231

(57) ABSTRACT

An apparatus for receiving multimedia content over a multicast enabled network includes a communications module, a stream assembly module, and a display module. The communications module receives and stores a plurality of multicast data packets pertaining to one or more video streams on a client device. The stream assembly module assembles at least a portion of the data packets pertaining to a video stream into a video stream. The display module displays an assembled video stream.

### FIELD

This invention relates to receiving multicast content and more particularly relates to a multicast client for receiving multimedia content over a multicast enabled network.

### BACKGROUND

Attending live performances at large scale venues has various advantages and disadvantages compared to viewing a remote broadcast of the performance. Live performances give attendees a sense of excitement that is difficult to replicate through remote viewing. Attendees may enjoy the direct view of the live proceedings as well as the ambiance and energy provided by the presence of other attendees. For example, attending a professional sporting event at a large sporting arena or stadium can offer excitement and experience not possible in any other way. In addition to being present at an exciting event with other attendees, individuals may also benefit from the ability to make purchases of food, beverages, memorabilia, or other items. Rather than preparing their own food, venue attendees often have a wide array of delicious food options that require no personal effort in preparation. However, in order to obtain the food at a venue, an individual must often get out of his or her seat, squeeze past neighboring attendees, walk a significant distance to reach food vendors, wander around trying to determine the available options, and/or wait in long lines. This time consuming process may result an attendee missing part of the live performance. As a result, some individuals may decide not to purchase anything at all.

Watching a remote broadcast of a live performance also has certain advantages over live attendance. Broadcasts of sporting events are often accompanied by informative and entertaining commentary/analysis. In addition, viewers often get the benefit of multiple replays from different viewing angles up close. Viewers can also keep track of other news or events more easily. Furthermore, a broadcast of a sporting event may actually provide a better view of the competition compared to certain locations within the live venue due to poor sight lines and/or long distances. For example, the upper sections of a football stadium or basketball arena may be far enough away that watching the game is, at least in some way, worse than viewing the game on a television broadcast.

The proliferation of personal mobile devices capable of receiving rich multimedia content wirelessly has the potential to give users the best of both worlds. Attendees of live events may be able to enjoy the atmosphere of a live event without sacrificing the advantages of remote viewing. In large scale venues with large crowds, however, the limited bandwidth of wireless networks and the use of traditional unicasting to deliver digital content results in gridlocked networks and poor network performance.

### SUMMARY

An apparatus for receiving multimedia content over a multicast enabled network includes a communications module, a stream assembly module, and a display module. In one embodiment, the communications module receives and stores a plurality of multicast data packets pertaining to one or more video streams on a client device. In another embodiment, the communications module also receives a plurality of multicast data packets containing information regarding one or more items for sale, where the information includes item names, descriptions, and prices. In a certain embodiment, the stream assembly module assembles at least a portion of the data packets pertaining to a video stream into a video stream. In an embodiment, the display module displays an assembled video stream. In another embodiment, the display module is capable of displaying the assembled video stream and one or more items for sale at substantially the same time. In an embodiment, the apparatus also includes a sales module that transmits a purchase order of the one or more items for sale to a point of sale.

In a certain embodiment, the client device is selected from the group consisting of a laptop computer, a desktop computer, a tablet computer, a smartphone, and a television. In one embodiment, the apparatus also includes an internal streaming module and internal receiver module. In an embodiment, the internal streaming module streams the video stream assembled by the stream assembly module to a local port on the client device. In another embodiment, the internal receiver receives an assembled video stream from the local port on the client device. In a further embodiment, the assembled video stream displayed by the display module is the assembled video stream received by the internal receiver module.

A system for receiving multimedia content over a multicast enabled network includes one or more video encoding servers, a multicast module, and a multicast client apparatus. In one embodiment, the multicast module processes one or more video streams from a video encoding server into multicast data packets. In an embodiment, the multicast client apparatus includes a communications module, a stream assembly module, and a display module. In one embodiment, the communications module receives and stores a plurality of multicast data packets pertaining to one or more video streams on a client device. In another embodiment, the communications module also receives a plurality of multicast data packets containing information regarding one or more items for sale, where the information includes item names, descriptions, and prices. In a certain embodiment, the stream assembly module assembles at least a portion of the data packets pertaining to a video stream into a video stream. In an embodiment, the display module displays an assembled video stream. In another embodiment, the display module is capable of displaying the assembled video stream and one or more items for sale at substantially the same time. In an embodiment, the apparatus also includes a sales module that transmits a purchase order of the one or more items for sale to a point of sale.

In a certain embodiment, the client device is selected from the group consisting of a laptop computer, a desktop computer, a tablet computer, a smartphone, and a television. In one embodiment, the apparatus also includes an internal streaming module and internal receiver module. In an embodiment, the internal streaming module streams the video stream assembled by the stream assembly module to a local port on the client device. In another embodiment, the internal receiver receives an assembled video stream from the local port on the client device. In a further embodiment, the assembled video stream displayed by the display module is the assembled video stream received by the internal receiver module.

A computer program product for receiving multimedia content over a multicast enabled network receives and stores a plurality of multicast data packets pertaining to one or more video streams on a client device, assembles at least a portion of the data packets pertaining to a video stream into a video stream, streams the assembled video stream to a local port on the client device, receives the assembled video stream from the local port on the client device, and displays the assembled video stream.

A method for receiving multimedia content over a multicast enabled network including receiving and storing a plurality of multicast data packets pertaining to one or more video streams on a client device, assembling at least a portion of the data packets pertaining to a video stream into a video stream, streaming the assembled video stream to a local port on the client device, receiving the assembled video stream from the local port on the client device, and displaying the assembled video stream. In one embodiment, further including displaying the assembled video stream and one or more items for sale at substantially the same time. In another embodiment, further including transmitting a purchase order of the one or more items for sale to a point of sale. In a further embodiment, further including comprising receiving and storing a plurality of multicast data packets containing information regarding one or more items for sale, wherein the information comprises one or more of item names, item descriptions, and item prices. In yet another embodiment, the client device is selected from a group consisting of a laptop computer, a desktop computer, a tablet computer, a smartphone, and a television.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for receiving multimedia content over a multicast enabled network;

FIG. 2 is a schematic block diagram illustrating one embodiment of an apparatus for receiving multimedia content over a multicast enabled network;

FIG. 3 is a schematic block diagram illustrating another embodiment of an apparatus for receiving multimedia content over a multicast enabled network;

FIG. 4A is an example screenshot illustrating one embodiment of a computer program product for receiving multimedia content over a multicast enabled network.

FIG. 4B is an example screenshot illustrating one embodiment of a computer program product for receiving multimedia content over a multicast enabled network.

FIG. 4C is an example screenshot illustrating one embodiment of a computer program product for receiving multimedia content over a multicast enabled network.

FIG. 4D is an example screenshot illustrating one embodiment of a computer program product for receiving multimedia content over a multicast enabled network.

FIG. 4E is an example screenshot illustrating one embodiment of a computer program product for receiving multimedia content over a multicast enabled network.

FIG. 5 is a diagram 500 illustrating an example of wireless coverage by two radio antennas at a high capacity venue.

FIG. 6 is a diagram 600 illustrating another example of wireless coverage by two radio antennas at a high capacity venue.

FIG. 7 is a schematic flow chart diagram illustrating one embodiment of a method for receiving multimedia content over a multicast enabled network.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP, Objective C, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a wide area network (WAN), or a wireless network, or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of preceding figures Like numbers refer to like elements in all figures, including alternate embodiments of like elements.

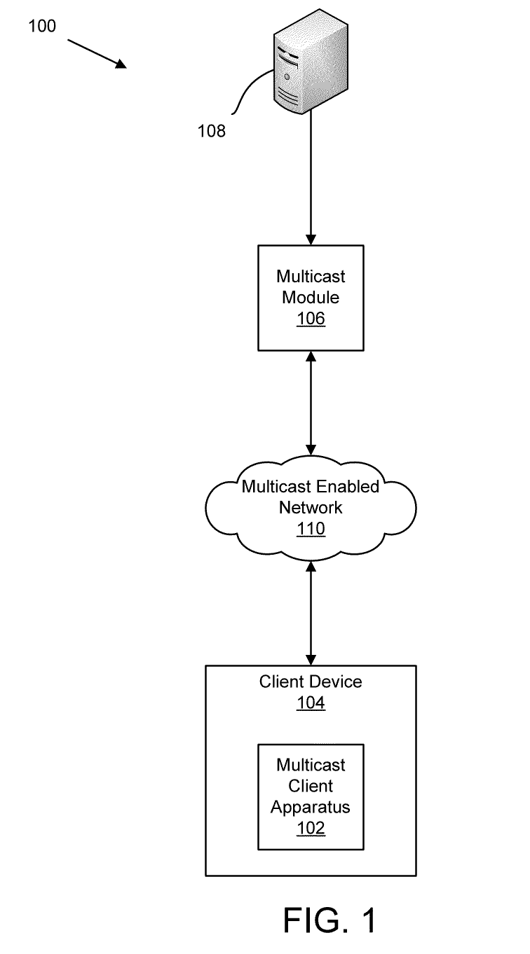

FIG. 1 is a schematic block diagram illustrating one embodiment of a system for receiving multimedia content over a multicast enabled network. The system 100 includes a multicast client apparatus 102 on a client device 104, a video encoding server 106, a multicast module 108, and a multicast enabled network 110, which are described below.

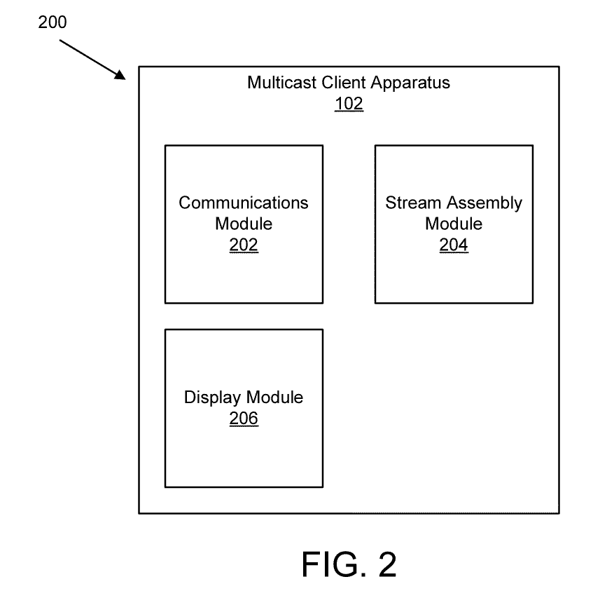

In one embodiment, the system 100 includes a multicast client apparatus 102 on a client device 104. The multicast client apparatus 102 allows a client device 104 to receive multimedia content over a multicast enabled network. The multicast client apparatus 102 is described in more detail with respect to the apparatus 200 in FIG. 2. The client device 104 may be any device capable of receiving multimedia content from a server through a multicast enabled network 110 and displaying the multimedia content. For example, the client device 104 may be laptop or desktop computer. In another example, the client device 104 may be a tablet (e.g., iPad, Kindle Fire, Nook). In a further example, the client device 104 may be a smartphone (e.g., iPhone, Blackberry, Android phone). The client device 104 could also be a television.

The video encoding server 106 encodes video data into different video formats for transmission. The video encoding server 106 may receive video data from a variety of sources. For example, the video encoding server 106 may receive raw video data directly from one or more cameras filming a live event (e.g., concert, sporting event, parade). In another example, the video encoding server 106 may receive video data as a file. In a further example, the video encoding server 106 may receive video data from another server. The video encoding server 106 can encode video data into different video formats (e.g., MPEG-2, H.264, Flash). One of skill in the art will recognize other video formats.

The multicast module 108 processes one or more video streams from a video encoding server 106 into data packets and multicasts the data packets. In one embodiment, the multicast module 108 resides on the video encoding server 106. In another embodiment, the multicast module 108 resides on a different server. The multicast module 108 processes video stream data into data packets and multicasts the data packets. In addition to creating multicast data packets from one or more video streams, in one embodiment the multicast module 108 also creates data packets from non-video data streams and multicasts these data packets. The non-video data packets may be used for a variety of purposes. In an embodiment, the non-video data packets may contain information regarding one or more items for sale for viewing by a user of the client device 104, such as a list of items, the item descriptions, and/or the latest price of each item. In another embodiment, the non-video data packets may contain news or sports score updates for viewing by a user of the client device 104. In one embodiment, the multicast module 108 multicasts data packets by creating a multicast socket bound to a multicast group address and sending each data packet through the socket. One of skill in the art will recognize other ways of multicasting data packets.

A data packet may contain different types of metadata that can be used by the multicast client apparatus 102. For example, a data packet may include metadata identifying a video's encoding format. In another example, a data packet may include metadata identifying which video stream it belongs to, or alternatively, what type of non-video data the data packet is carrying. In a further example, a data packet may include metadata identifying the size of the data payload. The size of a data packet may be vary. In one embodiment, each data packet and its data payload is approximately the same size. In another embodiment, the size of each data packet may vary. For example, packet size may vary with the available network bandwidth.

The multicast module 108 multicasts the data packets it creates from the one or more video streams it receives. Because a multicast sender only transmits each multicast data packet once, the multicast module 108 may use forward error correction to control and fix errors in data transmission. For example, the multicast module 108 may include redundant data in a data packet to help detect and fix errors in the transmitted data. One of skill in the art will recognize specific forward error correction techniques that may be used by a multicast module 108.

The client device 104 and server that the multicast module 108 resides on are connected by a multicast enabled network 110. The multicast enabled network 110 may include a local area network (“LAN”), a wide area network (“WAN”), wireless network, cellular network, the internet, or the like.

FIG. 2 is a schematic block diagram illustrating one embodiment of an apparatus for receiving multimedia content over a multicast enabled network. The apparatus 200 include one embodiment of a multicast client apparatus 102 with a communications module 202, a stream assembly module 204, and a display module 206, which are described below.

The communications module 202 receives and stores a plurality of multicast data packets pertaining to one or more video or non-video data streams. The communications module 202 may receive the plurality of multicast data packets in a variety of ways. For example, the communications module 202 may subscribe to a multicast group address to receive all data packets sent to that the group address. One of skill in the art will recognize other ways of receiving multicast data packets.

Upon receiving a data packet, the communications module 202 stores each packet on the client device for later use. In one embodiment, the communications module 202 will store the entire data packet. Alternatively, the communications module 202 will store only the data payload of the data packet. Before the contents of a data packet is stored, the communications module may examine the contents of the data packet for a variety of purposes. In one embodiment, the communications module 202 may examine the metadata accompanying the data packet to determine the size of the data payload that should be stored so that the data payload can be parsed from the data packet. In a further embodiment, the communications module 202 may examine the metadata to determine which video stream a data packet belongs to so that data packets pertaining to a specific video stream are stored together. For example, data packets pertaining to a particular video stream may be stored with filenames containing the name of the video stream. Similarly, in a certain embodiment, the communications module 202 may examine the metadata to determine if the data packet is non-video data (e.g., item list, item prices, news updates, sports score updates) and if so, where it should be stored for future access.

The stream assembly module 204 assembles a video stream from at least a portion of the data stored on the client device 104 that pertain to a video stream. In an embodiment, the stream assembly module 204 assembles a video stream using more recently received data packets. For example, the stream assembly module 204 may choose to start assembling a video stream starting at the 100^{th} data packet pertaining to the video stream. In one embodiment, a video stream assembled by the stream assembly module 204 may be composed of only a minimum number of data packets. In an alternate embodiment, a video stream assembled by the stream assembly module 204 may be composed of a minimum number of bytes of data. The stream assembly module 204 may use either entire data packets or just data payloads from data packets to assemble a video stream. In one embodiment, as the stream assembly module 204 assembles and arranges the data in their proper order to create a video stream, it checks for missing data payloads or packets. If there is a missing data payload or packet, the stream assembly module 204 will use redundant data from data packets near the gap to reconstruct the missing data packet (i.e., forward error correction). Similarly, the stream assembly module 204 will apply forward error correction to fix errors in existing data. One of skill in the art will recognize specific ways of performing forward error correction to reconstruct missing data or fix errors in the data. If there is no missing data, the stream assembly module 204 will remove the redundant data from each packet before assembling the data into a video stream.

In one embodiment, the display module 206 displays an assembled video stream to the user of the client device. In another embodiment, the assembled video stream is the video stream assembled by the stream assembly module 204. In addition to displaying an assembled video stream, the display module 206 may also displays an assembled video stream and other content at substantially the same time. For example, the display module 206 may display a video of a live sporting event and an overlay menu on top of the video stream with pictures and prices of items for sale (e.g., souvenirs, food). In this example, the display module handles the display of the various items for sale, purchase options, purchase orders, and transaction confirmations. In another example, the display module 206 may display a video of a live sporting event and scrolling news/sports updates on an edge of the video stream. In an embodiment, the display module 206 is also responsible for receiving, interpreting, and responding to user input on the client device 104. In this embodiment, the display module 206 may have “listeners” to receive different types of user input and respond appropriately. User input can include, but is not limited to, keyboard entry, mouse movement, mouse clicks, styluses, touch gestures, and voice commands. One of skill in the art will recognize other forms of user input.

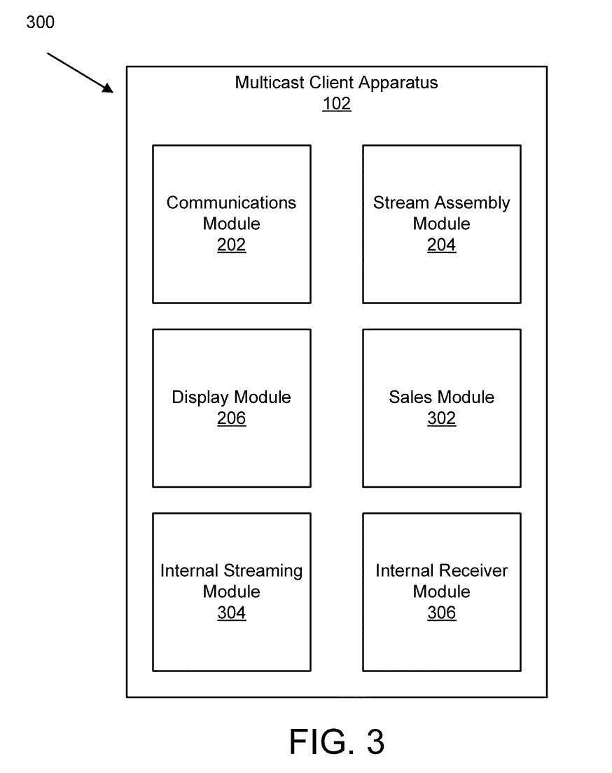

FIG. 3 is a schematic block diagram illustrating another embodiment of an apparatus for receiving multimedia content over a multicast enabled network. The apparatus 300 include another embodiment of a multicast client apparatus 102 with a communications module 202, a stream assembly module 204, and a display module 206, which are substantially similar to those described above in relation to apparatus 200 in FIG. 2. The apparatus 300 also includes the sales module 302, the internal streaming module 304, and the internal receiver module 306, which are described below.

The sales module 302 receives order requests and/or manages the ordering process. According to one embodiment, the sales module 302 receives order requests via user input on a client device. In another embodiment, the sales module 302 may also provide messages to users if an ordered item is not available. For example, if a store or vendor is out of a particular item it may not be possible to fulfill the order.

The details and/or format of an order created by the sales module 302 may vary significantly. According to one embodiment of ordering food at a large sporting venue, the sales module 302 may require an order to include one or more of item details, payment details, and/or seat location. Other details may be required, including but not limited to, whether seat delivery is requested and the customer's ticket number.

According to one embodiment, the payment method and payment details may be directed to a debit card payment, credit card payment, e-check payment, PayPal payment, or a variety of other remote payment methods known in the art. If the payment method and details are directed towards a method of remote payment, the sales module 302 may then take steps to initiate a payment transaction. According to one embodiment, the sales module 302 may provide the payment method and payment details to a point of sale. In one embodiment, a point of sale may be a server used to complete financial transactions.

If the payment transaction is successful, the sales module 302 may then transmit the order to one or more vendors. For example, if an order request includes a beverage item and a sports memorabilia item, the sales module 302 may place the order with the corresponding beverage vendor and the corresponding sports memorabilia store. According to one embodiment, the sales module 302 may provide at least a portion of the order details to the corresponding vendor and/or store. The vendor and/or store may then take steps to prepare and/or deliver the ordered items.

In one embodiment, the amount paid in a successful payment transaction may be divided among a plurality of parties. For example, a portion of the amount paid may be provided to one or more of the owner of a venue, a vendor or store owner.

In at least one embodiment, the sales module 302 may provide a message to the user to inform a user of the success/failure of the order. For example, if the order is properly placed and a payment transaction is successfully performed, the sales module 302 may send a confirmation message to the client device to show that the order was placed, the payment transaction was successful and/or that the ordered items will be delivered to the indicated seat location. Details of the order request may be included in the order confirmation. Alternatively or additionally, the order confirmation may include information about a failure of a portion of the order or the complete order. Thus, the user of a client device that placed the order request may be informed of the status of the order and know if the order was successful or unsuccessful and whether the items will be delivered.

The internal streaming module 304 takes an assembled video stream and streams it to a local port on the client device. Some client devices (e.g., iPad, iPhone) restrict third party applications from directly displaying a video stream object assembled by the stream assembly module 204. In this particular situation, the internal streaming module 304 takes a video stream assembled by the stream assembly module 204 and streams it to a local port on the client device, where it is received by the internal receiver module 306. The internal receiver module 306, in this case, encapsulates the assembled video stream within an object that can be passed off to the display module 206, which then displays the assembled video stream.

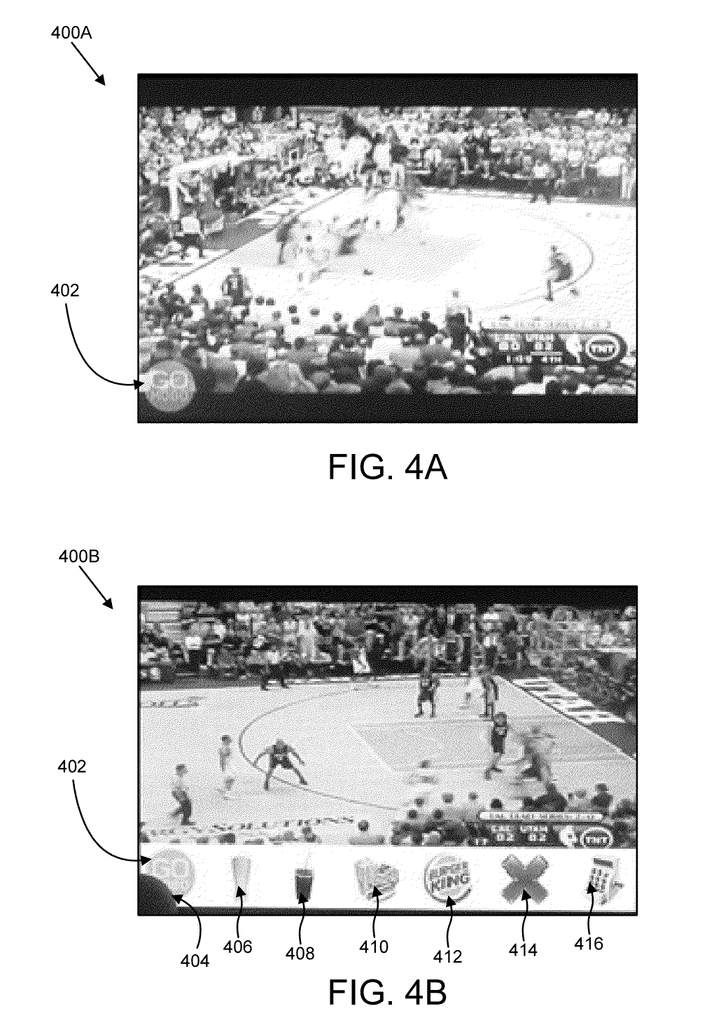

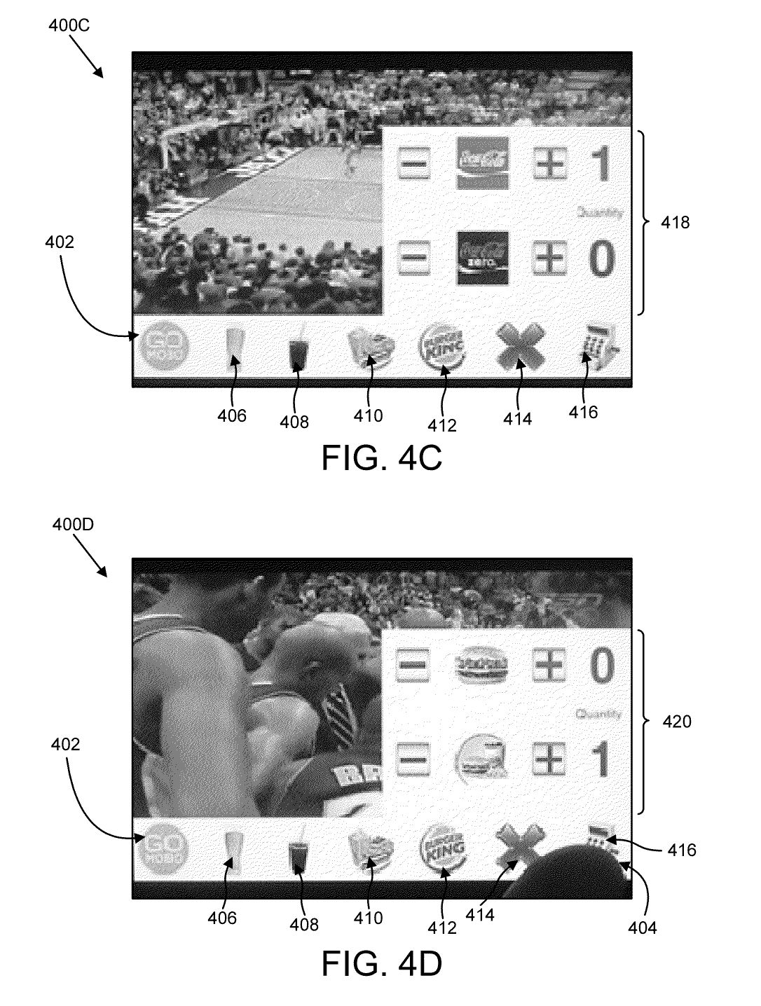

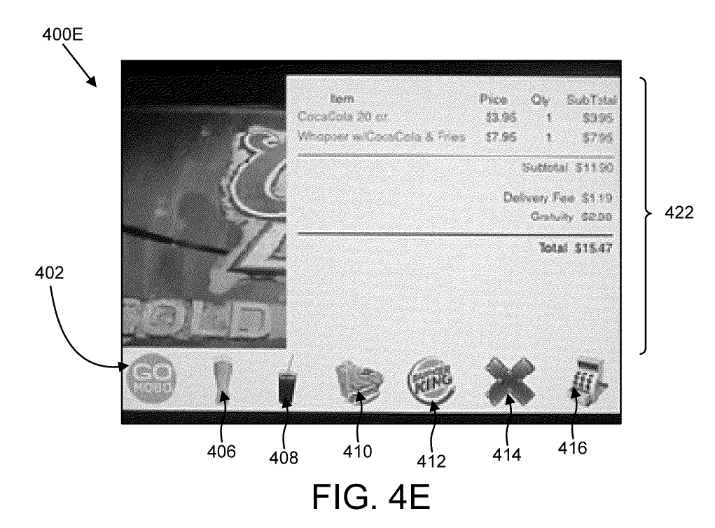

FIGS. 4A-4E are example screenshots illustrating one embodiment of a computer program product for receiving multimedia content over a multicast enabled network.

FIG. 4A shows a screenshot 400A of a video stream displayed by the multicast client apparatus 100. In this embodiment, the video stream is of an NBA basketball game. The screenshot 400A also includes an icon 402 that may be used to open an ordering menu. According to one embodiment, the display of the icon 402, menu, and menu options in this screenshots 400A-400E are handled by the display module 206. In one embodiment, the content of the displayed menus, including the icon 402, is based upon the information related to items for sale received by the communications module 202. In another embodiment, the icon 402 and menu related information may be read from static configuration files on the client device 104. One of skill in the art will recognize other ways of overlaying an icon 402 and other visual elements on top of a video stream.

FIG. 4B shows screenshot 400B after a user has selected the icon 402 by tapping it with a finger 404. In one embodiment, in response to this touch input, the display module 106 may retrieve the information regarding items for sale received and stored by the communications module 102 and display them as menu options 406-416. In this embodiment, it is possible for vendors to adjust their menu options and prices dynamically by streaming the latest information to the multicast client apparatus 102 via the multicast module 106. One of skill in the art will recognize that there are alternate ways of visualizing menu and food ordering options.

FIGS. 4C-4D show screenshots 400C and 400D where a user is making menu selections. In 400C and 400D, in response to user input selecting the soft drink icon 408 and hamburger icon 412, the display module 106 displays submenu and quantity selection options 418, 420. In this example, as the user makes menu selections, the sales module 302 tracks the user's selections in the background. When the user finalizes his/her order and initiates the payment transaction, the sales module 302 transmits the user's order to a point of sale.

FIG. 4E shows screenshot 400E where a user has finalized his/her order and completed the transaction. In this example, the display module 106 shows a confirmation 422 of the user's order as provided by the sales module 302.

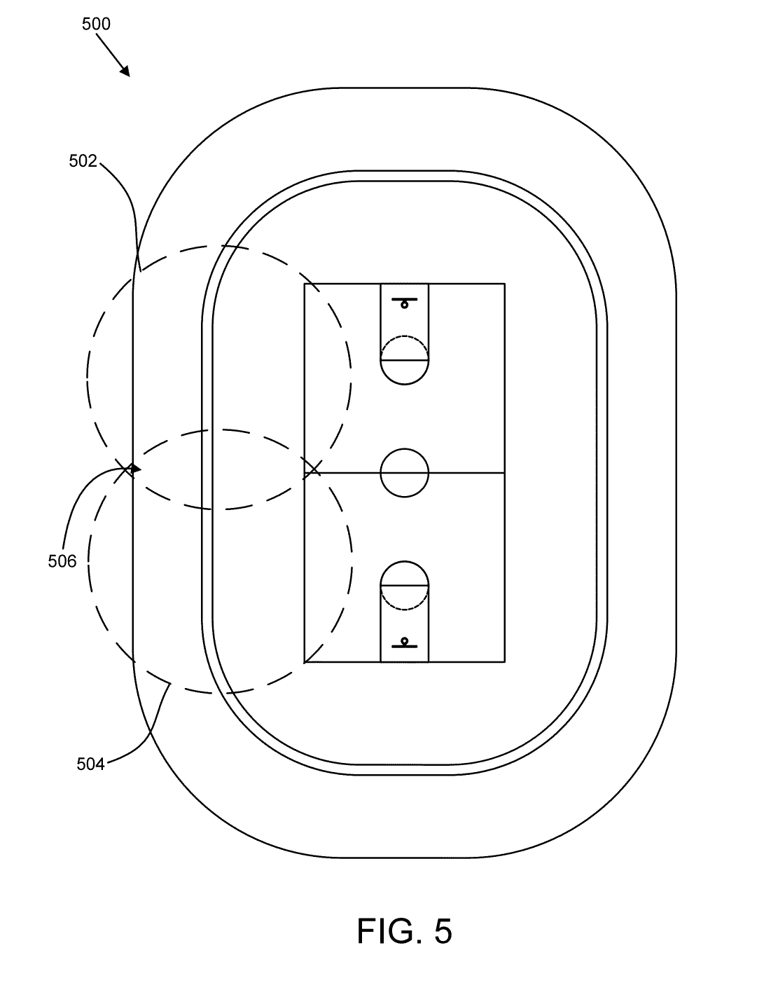

FIG. 5 is a diagram 500 illustrating an example of wireless coverage by two radio antennas at a high capacity venue (e.g., basketball arena). The diagram 500 depicts a first wireless coverage area 502 and a second wireless coverage area 504 which form an overlap region 506. In this example, the wireless coverage areas 502, 504 are areas where a client device having a multicast client apparatus 102 may receive multimedia content. A user in overlap region 506 attempting to access multimedia content may experience considerable difficulties. For example, in the overlap region 506 the client device 102 of the user may be repeatedly switching between the radios that provide the respective wireless coverage areas 502, 504. Repeated switching may cause significant delay in obtaining content and may cause the display of any content to be inconsistent or may even result in an inability to display the content.

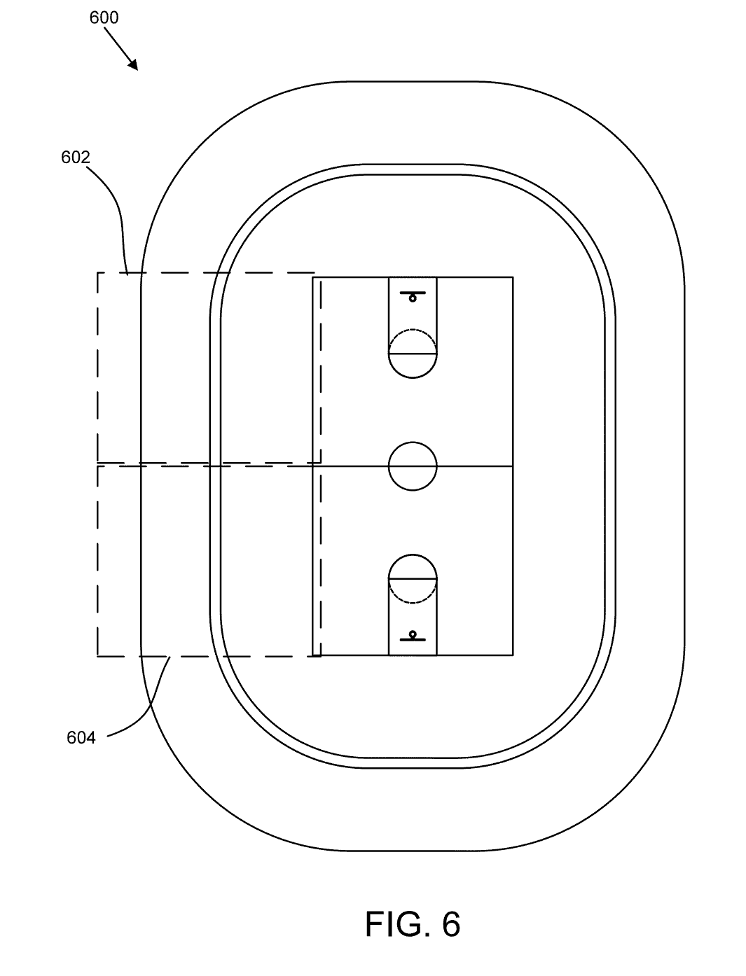

FIG. 6 is a diagram 600 illustrating another example of wireless coverage by two radio antennas at a high capacity venue (e.g., basketball arena). The diagram 600 depicts a first wireless coverage area 602 and a second wireless coverage area 604 which do not overlap or overlap very little. In this example, the wireless coverage areas 602, 604 are areas where a client device 104 may receive multimedia content using the multicast client apparatus 102. FIG. 6 shows that the shape of the wireless coverage areas 602, 604 can be controlled with the use of directional antenna arrays and/or reflectors. By controlling the shape of the coverage areas 602, 604 the overlap between the coverage areas 602 and 604 may be reduced and/or minimized. This may help with the repeated switching between radios as may be experienced in the overlapping area 506 of FIG. 5.

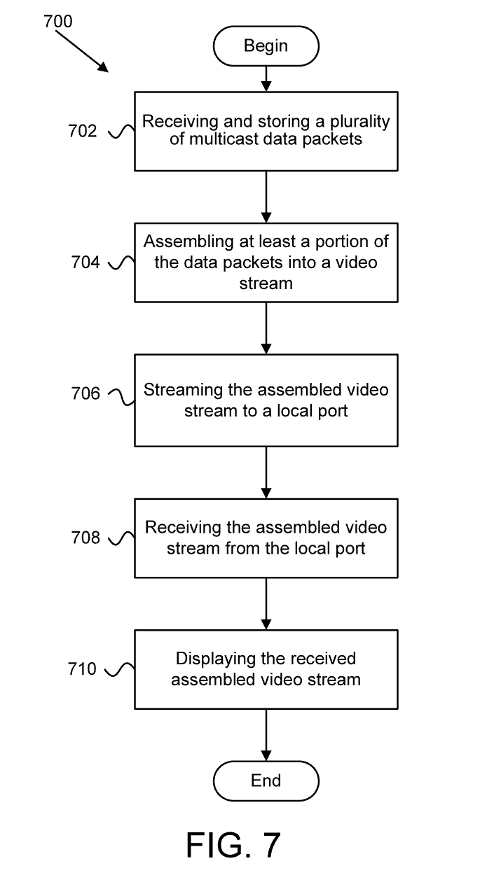

FIG. 7 is a schematic flow chart diagram illustrating one embodiment of a method for receiving multimedia content over a multicast enabled network. The method 700 begins and in one embodiment, the communications module 202 receives and stores 702 a plurality of multicast data packets pertaining to one or more video streams on a client device 104. In one embodiment, the method 700 also includes receiving and storing multicast data packets containing information regarding one or more items for sale, where the information includes one or more of item names, descriptions, and prices. The method 700 assembles 704 at least a portion of the data packets pertaining to a video stream into a video stream. The method 700 streams 706 the assembled video stream to a local port on the client device. The method 700 receives 708 the assembled video stream from the local port on the client device. The method 700 displays 710 the assembled video stream and the method 700 ends. In one embodiment, the method 700 displays the assembled video stream and one or more items for sale at substantially the same time. In another embodiment, the method 700 also includes transmitting a purchase order of one or more items for sale.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for receiving multimedia content over a multicast enabled network, the apparatus comprising:
a communications module that receives and stores a plurality of multicast data packets pertaining to one or more video streams on a client device;
a stream assembly module that assembles at least a portion of the data packets pertaining to a video stream into a video stream; and
a display module that displays an assembled video stream,
wherein at least a portion of the communications module, the stream assembly module, and the display module comprise one or more of hardware and executable code, the executable code stored on one or more computer readable storage media.

2. The apparatus of claim 1, wherein the display module is capable of displaying the assembled video stream and one or more items for sale at substantially the same time.

3. The apparatus of claim 2, further comprising a sales module that transmits a purchase order of the one or more items for sale to a point of sale.

4. The apparatus of claim 2, wherein the communications module further receives a plurality of multicast data packets containing information regarding one or more items for sale, wherein the information comprises one or more of item names, item descriptions, and item prices.

5. The apparatus of claim 1, wherein the client device is selected from a group consisting of a laptop computer, a desktop computer, a tablet computer, a smartphone, and a television.

6. The apparatus of claim 1, further comprising:
an internal streaming module that streams the video stream assembled by the stream assembly module to a local port on the client device; and
an internal receiver module that receives an assembled video stream from the local port on the client device;
wherein the assembled video stream displayed by the display module is the assembled video stream received by the internal receiver module.

7. A system for receiving multimedia content over a multicast enabled network, the system comprising:
one or more video encoding servers;
a multicast module that processes one or more video streams from a video encoding server into multicast data packets; and
a multicast client apparatus, wherein the multicast apparatus comprises
a communications module that receives and stores a plurality of multicast data packets pertaining to one or more video streams on a client device;
a stream assembly module that assembles at least a portion of the data packets pertaining to a video stream into a video stream;
an internal streaming module that streams the assembled video stream to a local port on the client device;
an internal receiver module that receives the assembled video stream from the local port on the client device; and
a display module that displays the assembled video stream.

8. The system of claim 7, wherein the display module is capable of displaying the assembled video stream and one or more items for sale at substantially the same time.

9. The system of claim 8, wherein the multicast client module further comprises a sales module that transmits a purchase order of the one or more items for sale to a point of sale.

10. The system of claim 8, wherein
the multicast module further processes one or more data streams containing information regarding one or more items for sale into multicast data packets; and
the communications module further receives a plurality of multicast data packets containing information regarding one or more items for sale, wherein the information comprises one or more of item names, item descriptions, and item prices.

11. The system of claim 7, wherein the client device is selected from a group consisting of a laptop computer, a desktop computer, a tablet computer, a smartphone, and a television.

12. The system of claim 7, wherein the multicast client apparatus further comprises:
an internal streaming module that streams the video stream assembled by the stream assembly module to a local port on the client device; and
an internal receiver module that receives an assembled video stream from the local port on the client device;
wherein the assembled video stream displayed by the display module is the assembled video stream received by the internal receiver module.

13. A computer program product for receiving multimedia content over a multicast enabled network, the computer program product comprising a computer readable storage medium having program code embodied therein, the program code readable/executable by a process to:
receive and store a plurality of multicast data packets pertaining to one or more video streams on a client device;
assemble at least a portion of the data packets pertaining to a video stream into a video stream;
stream the assembled video stream to a local port on the client device;
receive the assembled video stream from the local port on the client device; and
display the assembled video stream.

14. The computer program product of claim 13, wherein to assemble at least a portion of the data packets pertaining to a video stream into a video stream further comprises performing forward error correction.

15. A method for receiving multimedia content over a multicast enabled network, the method comprising:
receiving and storing a plurality of multicast data packets pertaining to one or more video streams on a client device;
assembling at least a portion of the data packets pertaining to a video stream into a video stream;
streaming the assembled video stream to a local port on the client device;
receiving the assembled video stream from the local port on the client device; and
displaying the assembled video stream.

16. The method of claim 15, further comprising displaying the assembled video stream and one or more items for sale at substantially the same time.

17. The method of claim 16, further comprising transmitting a purchase order of the one or more items for sale to a point of sale.

18. The method of claim 16, further comprising receiving and storing a plurality of multicast data packets containing information regarding one or more items for sale, wherein the information comprises one or more of item names, item descriptions, and item prices.

19. The method of claim 15, wherein assembling at least a portion of the data packets pertaining to a video stream into a video stream further comprises performing forward error correction.

20. The method of claim 15, wherein the client device is selected from a group consisting of a laptop computer, a desktop computer, a tablet computer, a smartphone, and a television.
